(19) United States
(12) Patent Application Publication
(10) Pub. No.: US 2022/0132196 A1
(43) Pub. Date: Apr. 28, 2022

(54) TRANSMITTING METHOD, RECEIVING METHOD, TRANSMITTING DEVICE, RECEIVING DEVICE, AND TRANSMISSION SYSTEM FOR CONTROL INSTRUCTION IN LONG-DISTANCE TRANSMISSION

(71) Applicant: SHENZHEN LENKENG TECHNOLOGY CO.,LTD, Shenzhen (CN)

(72) Inventor: Binghai GAO, Shenzhen (CN)

(73) Assignee: SHENZHEN LENKENG TECHNOLOGY CO.,LTD, Shenzhen (CN)

(21) Appl. No.: 17/361,340

(22) Filed: Jun. 29, 2021

(30) Foreign Application Priority Data
Oct. 27, 2020 (CN) 202011166241.5

(51) Int. Cl. H04N 21/422; H04L 29/06; G08C 19/00; G06F 3/041; H04N 21/4363; G06F 13/42

(52) U.S. Cl. CPC H04N 21/42224; H04L 69/165; G08C 19/00; G06F 3/041; G06F 2213/0016; G06F 13/4282; G08C 2201/30; G06F 2213/0042; H04N 21/43635

(57) ABSTRACT

Disclosed is a transmitting method, a receiving method, a transmitting device, a receiving device, and a transmission system for a control instruction in long-distance transmission. The transmitting method comprises the follows. A control instruction is obtained by a receiving device via a first transmission medium interface. The control instruction is encapsulated by the receiving device to obtain a packet including the control instruction. The packet is transmitted by the receiving device to a transmitting device via a second transmission medium interface. By adopting the disclosure, control of the video source device connected to the transmitting device can be achieved by transmitting the control instruction via a cable or optical fiber, and the user experience is high.

### CROSS REFERENCE TO RELATED APPLICATION

The present application claims priority to Chinese Patent Application Serial No. 202011166241.5 on Oct. 27, 2020, the disclosures of which is herein by incorporated by reference.

### TECHNICAL FIELD

The disclosure relates to the technical field of communication, and particularly to a transmitting method, a receiving method, a transmitting device, a receiving device, and a transmission system for a control instruction in long-distance transmission.

### BACKGROUND

A high definition multimedia interface (HDMI) transmission refers to long-distance transmission of HDMI source signal to a display device. Currently, HDMI is very widely used. With the development of technology, audio and video technology has also been rapidly developed. Most high-definition (HD) players, DVDs, set-top boxes, projectors, LCD TVs and PC computers all have HDMI.

In related technologies, in the HDMI transmission, the distance of a control instruction or control signal output from a control device effectively transmitted to a video source device is generally about 20 meters. Beyond this distance, the strength of the control instruction or control signal gradually decreases. And as the distance increases, the control signal is seriously distorted.

### SUMMARY

Based on the above problems and the shortcomings of the prior art, the disclosure provides a transmitting method, a receiving method, a transmitting device, a receiving device, and a transmission system for a control instruction in long-distance transmission to transmit the control instruction to video source devices for achieving control of the video source devices via cable or optical fiber. This shall result in higher user experience.

In a first aspect, a transmitting method for a control instruction in long-distance transmission is provided. The transmitting method includes the following.

The control instruction is obtained by the receiving device from a touch screen via a first transmission medium interface.

The control instruction is encapsulated by the receiving device to obtain a packet including the control instruction.

The packet is transmitted by the receiving device via a second transmission medium interface.

In a second aspect, a receiving method for a control instruction in long-distance transmission is provided. The receiving method includes the following.

A packet including the control instruction is received by the transmitting device via a third transmission medium interface.

The packet is decapsulated by the transmitting device to obtain the control instruction, where the control instruction is used to control a video source device connected to the transmitting device.

In a third aspect, the disclosure provides a receiving device. The receiving device comprises a memory and a processor coupled to the memory. The memory is configured to store application program code, and the processor is configured to invoke the application program code to: obtain control instruction via a first transmission medium interface, encapsulate the control instruction to obtain a packet comprising the control instruction, and transmit the packet via a second transmission medium interface. Where the second transmission medium interface comprises an optical port or a network port.

In a fourth aspect, the disclosure provides a transmitting device. The transmitting device comprises a memory and a processor coupled to the memory. The memory is configured to store application program code, and the processor is configured to: receive a packet comprising control instruction via a third transmission medium interface and decapsulate the packet to obtain the control instruction. Where the control instruction is used to control a video source device connected to the transmitting device.

The disclosure provides a transmitting method, a receiving method, a transmitting device, a receiving device and a transmission system for a control instruction in long-distance transmission. The transmitting method comprises the following. The control instruction is obtained by a receiving device via a first transmission medium interface. The control instruction is encapsulated by the receiving device to obtain a packet including the control instruction. The packet is transmitted by the receiving device to a transmitting device via a second transmission medium interface. With this disclosure, control instruction is transmitted to video source device connected to the transmitting device via cable or optical fiber for achieving controlling the video source device. The user experience is high.

### BRIEF DESCRIPTION OF THE DRAWINGS

In order to explain the technical solutions in implementations of the disclosure more clearly, the drawings used in the description of the implementations are briefly introduced below. Obviously, the drawings in the following description are some implementations of the disclosure. For ordinary technicians, other drawings can be obtained based on these drawings without paying creative work.

FIG. 1 is a schematic flowchart of a transmitting method for a control instruction in long-distance transmission according to the disclosure.

FIG. 2 is a schematic flowchart of a receiving method for a control instruction in long-distance transmission according to the disclosure.

FIG. 3 is a schematic structural diagram of a receiving device according to the disclosure.

FIG. 4 is a schematic structural diagram of a transmitting device according to the disclosure.

FIG. 5 is a schematic structural diagram of a transmission system for a control instruction in long-distance transmission according to the disclosure.

### DETAILED DESCRIPTION

The technical solutions in the disclosure will be described clearly and completely in combination with the accompanying drawings in the disclosure. Obviously, the described implementations are part of the implementations of the disclosure, but not all of the implementations. Based on the embodiments in the disclosure, all other embodiments obtained by those of ordinary skill in the art without creative work shall fall within the protection scope of this disclosure.

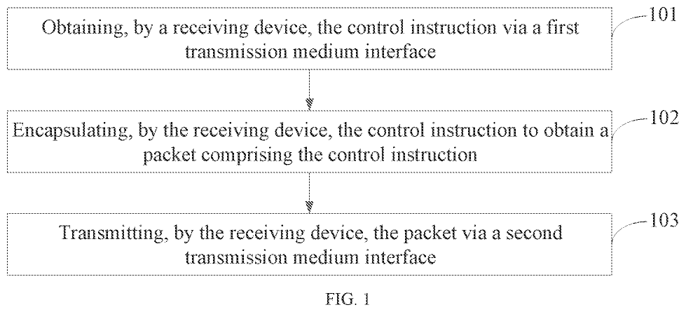

In order to better illustrate the transmitting method for a control instruction in long-distance transmission, the disclosure will be illustrated specifically in conjunction with FIG. 1.

FIG. 1 is a schematic flowchart of a transmitting method for a control instruction in long-distance transmission according to the disclosure. As shown in FIG. 1, the transmitting method may include, but is not limited to, the following.

At block 101, the control instruction is obtained by a receiving device from a touch screen via a first transmission medium interface.

Method 1

The receiving device obtains the control instruction from a control device connected to the receiving device via the first transmission medium interface integrated inside the receiving device. The control device includes a mouse, a keyboard or a user's control device (e.g., a stylus, optical pen, trackball, handheld computer or personal digital assistant (PDA)), which controls a speaker and other amplifier devices). The first transmission medium interface may include, but is not limited to, a universal serial bus (USB) interface, a RS232 interface, a serial peripheral interface (SPI), or an I2C interface, where the USB interface may include, but is not limited to, a USB 1.1 interface, a USB 1.0 interface, a USB 2.0 interface, a USB 3.0 interface, a USB 3.1 interface, or a Type-C interface.

Method 2

The receiving device obtains a touch screen instruction from a touch screen connected to the receiving device via the first transmission medium interface. The touch screen instruction includes user operation inputted to the touch screen (e.g., tapping the touch screen by user, sliding the touch screen by user, or space separated touching the touch screen by user). The control instruction includes the touch screen instruction.

It should be noted that the transmitting method for control instruction may further includes the following. before the receiving device obtains the control instruction from the control device connected to the receiving device via the first transmission medium interface, the control device receives the control instruction inputted by a user to the control device.

The transmitting method for the control instruction may further includes the following. Before the receiving device obtains the touch screen instruction from the touch screen connected to the receiving device via the first transmission medium interface, the touch screen receives the touch screen instruction inputted into the touch screen by the user.

It should be noted that the receiving device obtain control the instruction, via the first transmission medium interface in addition, the transmitting method may include the following.

The receiving device receives an infrared signal via a first infrared receiving tube, converts the infrared signal into an electrical signal, samples the electrical signal by a sampling module to obtain a full sampling signal, and demodulates the full sampling signal to obtain a binary coded signal and a pulse signal. The demodulation control data can be obtained according to the binary coded signal, the carrier frequency data can be obtained according to the pulse signal, a first signal is generated according to the binary coded signal and the carrier frequency data, and the receiving device can output the first signal to the transmitting device via a network port.

At block 102, the receiving device encapsulates the control instruction and obtains a packet including the control instruction.

According to an embodiment of the disclosure, the receiving device encapsulates the control instruction to obtain the packet including the control instruction, which may include, but is not limited to, the following methods.

Method 1

The receiving device encapsulates the control instruction through a user datagram protocol (UDP) and obtains a UDP packet including the control instruction. More specifically,

the receiving device encapsulates the control instruction through adding a UDP header and a UDP tail to the control instruction to obtain a UDP packet including the control instruction. The UDP header or the UDP tail may contain control information such as destination address, source address, port number, and marker bits, respectively.

Method 2

The receiving device encapsulates the control instruction through a custom communication protocol to obtain a custom protocol packet including the control instruction. More specifically,

the receiving device encapsulates the control instruction to obtain a custom protocol packet including the control instruction through adding a custom protocol header and a custom protocol tail to the control instruction. Where the custom protocol header or custom protocol tail may contain control information such as destination address, source address, port number, and marker bits, respectively. It should be noted that the custom communication protocol includes a simple communication protocol designed to keep the processing operation of the packet in the receiving device synchronized with the processing operation of the packet in the target device.

Method 3

The receiving device encapsulates the control instruction through a transmission control protocol (TCP) to obtain a TCP packet including the control instruction.

Method 4

The receiving device encapsulates the touch screen instruction through a communication protocol to obtain a packet including the touch screen instruction. The communication protocol may include, but is not limited to, a UDP, a custom communication protocol or a TCP.

At block 103, the receiving device transmits the packet via a second transmission medium interface.

According to an embodiment of the disclosure, the receiving device transmits the packet via the second transmission medium interface, which may include, but is not limited to, the following methods.

Method 1

When the first signal is a UDP packet including a control instruction, the receiving device transmits the UDP packet to a transmitting device via an optical port.

More specifically, the receiving device transmits the UDP packet to the transmitting device via the optical port (also known as fiber optic interface) and the fiber coupled to the optical port. Optionally, the length of the optical fiber may be 40 km, and the embodiment of the disclosure is not limited.

Method 2

When the first signal is the UDP packet including a control instruction, the receiving device transmits the UDP packet to the transmitting device via a network port.

More specifically, the receiving device transmits the UDP packet including control instruction to the transmitting device via the network port and a cable coupled to the network port (e.g., cat5, cat5e, cat6, Cat6a, or Cat7). Optionally, the length of the cable may be 70 m.

Method 3

When the first signal is a custom protocol packet including control instruction, the receiving device transmits the custom protocol packet to the transmitting device via the optical port.

Method 4

When the first signal is the custom protocol packet including the control instruction, the receiving device transmits the custom protocol packet to the transmitting device through the network port.

Method 5

When the first signal is a TCP packet including the control instruction, the receiving device transmits the TCP packet to the transmitting device via the optical port.

Method 6

When the first signal is the TCP packet including the control instruction, the receiving device transmits the TCP packet to the transmitting device via the network port.

It should be noted that FIG. 1 is only configured to explain the embodiment of the disclosure, which is not limited the disclosure.

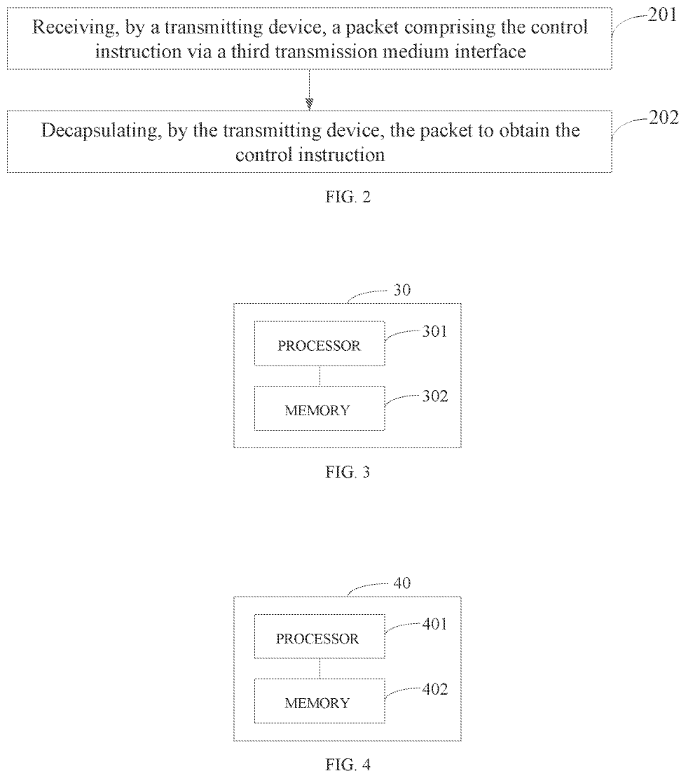

In order to better illustrate the receiving method for the control instruction in long-distance transmission, the disclosure will be illustrated specifically in conjunction with FIG. 2.

FIG. 2 is a schematic flowchart of a receiving method for the control instruction in long-distance transmission according to the disclosure. As shown in FIG. 2, the receiving method may include the following.

At block 201, the transmitting device receives a packet including the control instruction via a third transmission medium interface.

According to an embodiment of the disclosure, the transmitting device receives the packet including the control instruction through the third transmission medium interface, which may include, but is not limited to, the following methods.

Method 1

The transmitting device receives a user datagram protocol (UDP) packet transmitted from the receiving device via the network port.

The transmitting device receives the UDP packet transmitted from the receiving device via an internally integrated network port and a cable coupled to the network port (e.g., cat5, cat5e, cat6, Cat6a, or Cat7). Optionally, the length of the network cable may be 70 m.

Method 2

The transmitting device receives the UDP packet transmitted from the receiving device via the optical port.

The transmitting device receives the UDP packet transmitted from the receiving device via an optical fiber interface and based on the optical fiber. Optionally, the length of the optical fiber may be 40 km, and the embodiment of the disclosure is not limited.

Method 3

The transmitting device receives the custom protocol packet transmitted from the receiving device via the network port.

Method 4

The transmitting device receives the custom protocol packet transmitted from the receiving device via the optical port.

Method 5

The transmitting device receives a transmission control protocol (TCP) packet transmitted from the receiving device via the network port.

Method 6

The transmitting device receives the TCP packet transmitted from the receiving device via the optical port.

It should be noted that the transmitting device receive the packet including the control instruction via a third transmission medium interface in addition. the transmitting device may further receive the control instruction from a mouse, a keyboard or a user's control device (e.g., a stylus, a light pen, a trackball, a handheld computer or a personal digital assistant (PDA) connected to the transmitting device via a fifth transmission medium interface (e.g., a USB interface, a RS232 interface, a SPI or an I2C interface) on the transmitting device, and transmit the control instruction to the receiving device via the second transmission medium interface to control an output device connected to the receiving device (such as a monitor, a projector or speakers, etc.).

At block 202, the transmitting device decapsulates the packet to obtain a control instruction.

According to an embodiment of the disclosure, the control instruction is used to control the video source device connected to the transmitting device.

The transmitting device decapsulates the packet to obtain the control instruction, which may include, but is not limited to, the following.

Method 1

The transmitting device performs a decapsulation operation of the UDP packet through the UDP to obtain the control instruction.

More specifically, the transmitting device decapsulates the UDP packet through the UDP to obtain the control instruction as well as the UDP header and UDP tail, where the UDP header or UDP tail can contain information such as destination address, source address, port number, and marker bits, respectively.

Method 2

The transmitting device decapsulates the custom protocol packet through a custom communication protocol to obtain the control instruction.

More specifically, the transmitting device decapsulates the custom packet through the custom communication protocol to obtain the control instruction as well as custom protocol header and custom protocol tail, where the custom protocol header or custom protocol tail can contain information such as destination address, source address, port number, and tag bits, respectively.

Method 3

The transmitting device performs the decapsulation operation of the TCP packet through the TCP to obtain the control instruction.

More specifically, the transmitting device decapsulates the TCP packet through the TCP to obtain the control instruction as well as the TCP header and TCP tail, where the TCP header or TCP tail may contain information such as destination address, source address, port number, and marker bits, respectively.

Method 4

The transmitting device decapsulates the packet through the communication protocol to obtain a touch screen instruction. Where the touch screen instruction includes user operation input to the touch screen, and the control instruction includes the touch screen instruction. The packet may include, but is not limited to, the UDP packet, the TCP packet or the custom protocol packet.

It should be noted that the transmitting method include the following.

The transmitting device processes the packet to obtain the control instruction.

The transmitting device transmits the control instruction to the video source device (e.g., DVD, set-top box, or camera) via a fourth transmission medium interface to control the video source device outputting an audio and video data to the transmitting device via a high definition multimedia interface (HDMI), Type-C interface, DP interface, digital visual interface (DVI), or video graphics array (VGA) interface of the transmitting device.

Where the fourth transmission medium interface, may include, but is not limited to, a USB interface (e.g., USB 1.1 interface, USB 1.0 interface, USB 2.0 interface, USB 3.0 interface, USB 3.1 interface, or Type-C interface), a RS232 interface, DVI, or an I2C interface.

It should be noted that the video source device receives the control instruction transmitted from the transmitting device, and control the video source device (for example, audio and video data can be controlled, by the video source device according to the control instruction, to output to the transmitting device via the HDMI, Type-C interface, DP interface, VGA interface or DVI of the transmitting device) according to the control instruction.

It should be noted that the transmitting device receives the control instruction via the network port or the optical port in addition, receives the first signal, and parses the first signal to obtain carrier frequency data and a binary coded signal via the network port or the optical port. Where the network port and the optical port are internally integrated respectively in the transmitting device. The transmitting device loads the binary coded signal onto the carrier generated according to the carrier frequency data to obtain loaded signal and processes the loaded signal into infrared signal. The transmitting device transmits the infrared signal to the video source device connected with the transmitting device via an infrared emitting tube integrated inside the transmitting device, in order to achieve the control of the video source device (such as the switch of the playback content or volume adjustment).

In summary, the transmitting device receives the packet including the control instruction via the third transmission medium interface.

The transmitting device processes the packet to obtain the control instruction, and transmits the control instruction to the video source device to control the video source device connected to the transmitting device.

The disclosure provides a receiving device for transmitting control instruction in long-distance transmission, and the receiving device for transmitting control instruction in long-distance transmission shown in FIG. 3 can be used to perform the method described in the embodiment of FIG. 1.

As shown in FIG. 3, the receiving device 30 may include, but is not limited to, a processor 301 and a memory 302 coupled to the processor 301.

The memory 302 can be configured to store application program instruction.

The processor 301 may be configured to invoke application program instruction from the memory 302 to implement the transmitting method for the control instruction described in the embodiment of FIG. 1.

The receiving device 30 further includes an input interface and an output interface, in addition to the processor 301 and the memory 302.

The input interface can be configured to obtain the control instruction.

It should be noted that the input interface, specifically, may be configured to obtain the control instruction from a control device connected to the receiving device. Where the control device comprising a mouse and a keyboard, and the input interface, may include, but is not limited to, a USB interface, a RS232 interface, a SPI or an I2C interface.

The input interface, specifically, may further be configured to obtain a touch screen instruction from a touch screen connected to the receiving device 30, where the control instruction includes the touch screen instruction.

It should be noted that the processor 301 can be configured to execute the following.

The control instruction obtained, via the input interface, from the touch screen is encapsulated to obtain a packet including the control instruction.

The output interface may be configured to transmit the packet by the processor 301. The output interface may include, but is not limited to, a network port or a fiber optic interface.

The processor 301 is specifically configured to execute the following.

The control instruction is encapsulated to obtain a user datagram protocol (UDP) packet through the UDP, where the UDP packet includes the control instruction.

The control instruction is encapsulated through a custom communication protocol to obtain a custom protocol packet, and the custom protocol includes the control instruction.

The control instruction is encapsulated through a transmission control protocol (TCP) to obtain a TCP packet including the control instruction.

It should be understood that the receiving device 30 is only one example of what is provided in this disclosure, and the receiving device 30 may have more or fewer components than those shown, may combine two or more components, or may have different configurations of components implemented.

It will be understood that specific implementations of the functional components included in the receiving device 30 of FIG. 3 may be referred to the embodiment of FIG. 1 and will not be repeated here.

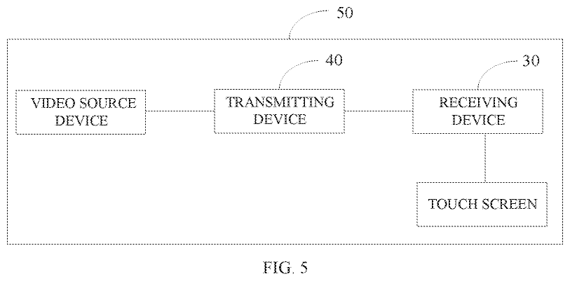

The disclosure provides a transmitting device for receiving the control instruction in long-distance transmission, and the transmitting device for receiving the control instruction in long-distance transmission shown in FIG. 4 can be configured to perform the method described in the embodiment of FIG. 2.

As shown in FIG. 4, the transmitting device 40 may include, but is not limited to, a processor 401 and a memory 402 coupled to the processor 401.

The memory 402 can be configured to store application program instruction.

The processor 401 may be configured to invoke application program instruction from the memory 402 to implement the receiving method for the control instruction described in the embodiment of FIG. 2.

It should be noted that the transmitting device 40 further includes an input interface and an output interface in addition to the processor 401 and the memory 402.

The input interface may be configured to receive the packet including the control instruction, where the input interface may include a network port or a fiber optic interface.

The processor 401 is configured to execute the following.

A packet is received via the input interface and decapsulated to obtain the control instruction.

The processor 401 is specifically configured to execute the following.

A user datagram protocol (UDP) packet is decapsulated through the UDP to obtain the control instruction.

The custom protocol packet is decapsulated through the custom communication protocol to obtain the control instruction.

A transmission control protocol (TCP) packet is decapsulated through the TCP to obtain the control instruction.

A packet is decapsulated through the communication protocol to obtain a touch screen instruction, where the touch screen instruction include user operation inputted to the touch screen.

The output interface is configured to execute the following.

The control instruction is transmitted to the video source device.

The touch screen instruction is transmitted to the video source device.

Where the output interface may include, but is not limited to, a USB interface, a digital visual interface (DVI), a RS232 interface, an I2C interface or a serial peripheral interface (SPI) interface.

It should be understood that the transmitting device 40 is only one example provided by this disclosure, and the transmitting device 40 may have more or fewer components than shown, may combine two or more components, or may have different configurations of components implemented.

It will be understood that specific implementations of the functional components included in the transmitting device 40 of FIG. 4 may be referred to the FIG. 2 embodiment and will not be repeated here.

The disclosure provides a transmission system for transmitting the control instruction in long-distance transmission, as shown in FIG. 5, the transmission system 50, which may include, but is not limited to, a receiving device as described in FIG. 3 and a transmitting device as described in FIG. 4. Where the receiving device 30 is connected to the transmitting device 40 by a cable or optical fiber.

It should be noted that the receiving device 30 may obtain the control instruction via an input interface of the receiving device 30, which may include, but is not limited to, a USB interface, a RS232 interface, an I2C interface, or a SPI.

The receiving device 30 may encapsulate the control instruction (e.g., a control instruction obtained from a control device connected to the receiving device 30, or a touch screen instruction obtained from a touch screen connected to the receiving device 30) to obtain a packet including the control instruction.

The receiving device 30 may transmit the packet obtained via the processor 301 to the transmitting device 30 via the output interface. Where the output interface may include, but is not limited to, a network port or an optical port.

The receiving device 30 transmits the UDP packet to the transmitting device 40 via the network port.

The receiving device 30 transmits the UDP packet to the transmitting device 40 via the optical port.

When the transmitting device 40 receives the packet transmitted from the receiving device 30 via the network port or optical port, the transmitting device 40 parses the packet to obtain the control instruction, and transmits the control instruction to the video source device connected with the transmitting device 40 via the USB interface, RS232 interface, SPI or I2C interface to realize the control of the video source device (e.g., switching of playback content, volume adjustment).

It should be noted that the specific embodiment of the receiving device 30 included in the transmission system of FIG. 5 can be referred to the embodiment of the receiving device in FIG. 3, and the specific embodiment of the transmitting device 40 can be referred to the embodiment of the transmitting device in FIG. 4.

Those ordinary skilled in the art may realize that the modules and algorithm steps of each example described in combination with the implementations of the disclosure can be performed by electronic hardware, computer software, or a combination thereof. In order to clearly explain the interchangeability of hardware and software, the composition and steps of each example have been described generally in terms of functions in the above description. Whether these functions are performed in hardware or software depends on the specific application and design constraints of the technical solution. Professional technicians can use different methods to implement the described functions for each specific application, but such implementation should not be considered to be beyond the scope of the disclosure.

Those skilled in the art can clearly understand that, for the convenience and brevity of the description, the specific working processes of the devices and modules described above can refer to the corresponding processes in the foregoing implementations of method, and are not repeated here.

In the several implementations provided in the disclosure, it should be understood that the disclosed equipment, device, and method may be implemented in other ways. For example, to describe the composition and steps of each example. Whether these functions are executed in hardware or software depends on the specific application of the technical solution and design constraints. Professional technicians can use different methods to implement the described functions for each specific application, but such implementation should not be considered beyond the scope of this disclosure.

The implementations of device and equipment described above are only schematic. For example, the division of the modules is only a logical function division. In actual implementation, there may be another division manner. For example, multiple modules or components may be combined or integrated into another device, or some features can be ignored or not be implemented.

In addition, the displayed or discussed mutual coupling or direct coupling or communication connection may be indirect coupling or communication connection via some interfaces, equipment, devices or modules, and may also be electrical, mechanical or other forms of connection.

The modules described as separate components may or may not be physically separated, and the components displayed as modules may or may not be physical modules, may be located in one place, or may be distributed on multiple network modules. Some or all of the modules may be selected according to actual needs to achieve the objects of the solutions in the implementations of the disclosure.

In addition, each functional module in each implementation of the disclosure may be integrated into one processing module, or each module may exist separately physically, or two or more modules may be integrated into one module. The above integrated modules may be implemented in the form of hardware or software functional modules.

When the integrated module is implemented in the form of a software functional module and sold or used as an independent product, it can be stored in a computer-readable storage medium. Based on this understanding, the technical solution of the disclosure essentially or a part that contributes to the existing technology, or all or part of the technical solution may be embodied in the form of a software product. The computer software product is stored in a storage medium which includes instructions to enable a computer device (which may be a personal computer, a server, or a network device, etc.) to perform all or part of the steps of the method described in the implementations of the disclosure. The foregoing storage media include: U-disks, mobile hard disks, read-only memory (ROM), random access memory (RAM), magnetic disks, or optical disks and other media that can store program codes.

The above is only a specific implementation of the disclosure, but the scope of protection of the disclosure is not limited to this. Any person skilled in the art can easily think of various equivalent modifications or replacements within the technical scope disclosed in the disclosure which should be covered by the protection scope of the disclosure. Therefore, the protection scope of the disclosure shall be subject to the protection scope of the claims.

What is claimed is:

1. A transmitting method for a control instruction in long-distance transmission, comprising:
obtaining, by a receiving device, the control instruction via a first transmission medium interface;
encapsulating, by the receiving device, the control instruction to obtain a packet comprising the control instruction; and
transmitting, by the receiving device, the packet via a second transmission medium interface.

2. The transmitting method according to claim 1, wherein
obtaining, by the receiving device, the control instruction via the first transmission medium interface comprises:
obtaining, by the receiving device, the control instruction from a control device connected to the receiving device via the first transmission medium interface; wherein
the control device is connected to the receiving device and comprises a mouse, a keyboard or a user control device; and
the first transmission medium interface comprises a universal serial bus (USB) interface, a RS232 interface, a serial peripheral interface (SPI) or an I2C interface.

3. The transmitting method according to claim 1, wherein
obtaining, by the receiving device, the control instruction via the first transmission medium interface comprises:
obtaining, by the receiving device, a touch screen instruction from a touch screen connected to the receiving device via the first transmission medium interface; wherein the touch screen instruction comprises a user operation inputted to the touch screen.

4. The transmitting method according to claim 2, wherein
encapsulating, by the receiving device, the control instruction to obtain the packet comprising the control instruction comprises:
encapsulating, by the receiving device, the control instruction through a user datagram protocol (UDP) to obtain a UDP packet comprising the control instruction;
encapsulating, by the receiving device, the control instruction through a custom communication protocol to obtain a custom protocol packet comprising the control instruction, or encapsulating, by the receiving device, the control instruction through a transmission control protocol (TCP) to obtain a TCP packet including the control instruction.

5. The transmitting method according to claim 3, wherein
encapsulating, by the receiving device, the control instruction to obtain the packet including the control instruction comprises:
encapsulating, by the receiving device, the touch screen instruction through the communication protocol to obtain a packet including the touch screen instruction; wherein the communication protocol comprises a UDP, a custom communication protocol or a TCP.

6. The transmitting method according to claim 5, wherein
transmitting, by the receiving device, the packet via the second transmission medium interface comprises:
transmitting, by the receiving device, the packet to the transmitting device via an optical port; or
transmitting, by the receiving device, the packet to the transmitting device via a network port.

7. A receiving method for a control instruction in long-distance transmission, comprising:
receiving, by a transmitting device, a packet comprising the control instruction via a third transmission medium interface;
decapsulating, by the transmitting device, the packet to obtain the control instruction; wherein the control instruction is used to control a video source device connected to the transmitting device.

8. The receiving method according to claim 7, wherein
the receiving method further comprises:
after decapsulating, by the transmitting device, the packet to obtain the control instruction, transmitting, by the transmitting device, the control instruction to the video source device via a fourth transmission medium interface to control the video source device outputting audio and video data to the transmitting device via a high definition multimedia interface (HDMI), a Type-C interface, a DP interface, a video graphics array (VGA) interface, or a digital visual interface (DVI) of the transmitting device.

9. The receiving method according to claim 8, wherein
transmitting, by the transmitting device, the control instruction to the video source device via the fourth transmission medium interface, comprises:
transmitting, by the transmitting device, the control instruction to the video source device via a universal serial bus (USB) interface of the transmitting device;
transmitting, by the transmitting device, the control instruction to the video source device via a RS232 interface of the transmitting device;
transmitting, by the transmitting device, the control instruction to the video source device via an I2C interface of the transmitting device; or
transmitting, by the transmitting device, the control instruction to the video source device via a serial peripheral interface (SPI) of the transmitting device.

10. The receiving method according to claim 7, wherein
receiving, by the transmitting device, the packet including the control instruction via the third transmission medium interface comprises:
receiving, by the transmitting device via a network port or an optical port, a user datagram protocol (UDP) packet transmitted from the receiving device;
receiving, by the transmitting device via the network port or the optical port, a custom protocol packet transmitted from the receiving device; or
receiving, by the transmitting device via the network port or the optical port, a transmission control protocol (TCP) packet transmitted from the receiving device.

11. The receiving method according to claim 7, wherein
decapsulating the packet by the transmitting device to obtain the control instruction comprises:
decapsulating, by the transmitting device, the packet through a communication protocol to obtain a touch screen instruction; wherein the touch screen instruction comprises a user operation inputted to the touch screen; the communication protocol comprises a UDP, a custom communication protocol or a TCP;
decapsulating, by the transmitting device, the UDP packet through a UDP to obtain the control instruction;
decapsulating, by the transmitting device, the custom protocol packet through the custom communication protocol to obtain the control instruction; or
decapsulating, by the transmitting device, the TCP packet through a TCP to obtain the control instruction.

12. The receiving method according to claim 10, wherein
the receiving method further comprises:
obtaining, by the transmitting device, the control instruction from a control device connected to the transmitting device via a fifth transmission medium interface; wherein the control device is connected to the transmitting device and comprises a mouse, a keyboard or a user control device connected to the transmitting device; and the fifth transmission medium interface comprises a USB interface, a RS232 interface, a SPI, or an I2C interface.

13. A receiving device, comprising:
a memory configured to store application program code; and
a processor coupled to the memory and configured to invoke the application program code to:
obtain control instruction via a first transmission medium interface;
encapsulate the control instruction to obtain a packet comprising the control instruction; and
transmit the packet via a second transmission medium interface; wherein the second transmission medium interface comprises an optical port or a network port.

14. The receiving device according to claim 13, wherein
the processor configured to encapsulate the control instruction to obtain the packet comprising the control instruction is configured to:
encapsulate the control instruction through a user datagram protocol (UDP) to obtain a UDP packet comprising the control instruction;
encapsulate the control instruction through a custom communication protocol to obtain a custom protocol packet comprising the control instruction; or
encapsulate the control instruction through a transmission control protocol (TCP) to obtain a TCP packet comprising the control instruction.

15. The receiving device according to claim 13, wherein
the processor configured to encapsulate the control instruction to obtain the packet comprising the control instruction is configured to:
encapsulate a touch screen instruction through the communication protocol to obtain the packet comprising the touch screen instruction; wherein the communication protocol comprises a UDP, a custom communication protocol, or a TCP.

16. The receiving device according to claim 13, wherein
the processor is further configured to:
convert an infrared signal obtained into an electrical signal;
sample the electrical signal to obtain a fully sampled signal;
demodulate the fully sampled signal to obtain a binary coded signal and a pulse signal;
obtain demodulation control data based on the binary coded signal;
obtain carrier frequency data based on the pulse signal; and
generate a first signal from the binary coded signal and the carrier frequency data, wherein the first signal is transmitted to the transmitting device via the second transmission medium interface.

17. A transmitting device, comprising:
a memory configured to store application program code; and
a processor coupled to the memory and configured to invoke the application program code to:
receive a packet comprising control instruction via a third transmission medium interface; and
decapsulate the packet to obtain the control instruction; wherein the control instruction is used to control a video source device connected to the transmitting device.

18. The transmitting device according to claim 17, wherein
the transmitting device further comprises:
a fourth transmission medium interface configured to transmit the control instruction to a video source device to control audio and video data outputted from the video source device to the transmitting device via a HDMI, a Type-C interface, a DP interface, a video graphics array (VGA) interface or a digital visual interface (DVI) of the transmitting device; wherein the fourth transmission medium interface comprises a universal serial bus (USB) interface, a RS232 interface, an I2C interface or a serial peripheral interface (SPI).

19. The transmitting device according to claim 17, wherein
the processor configured to decapsulate the packet to obtain the control instruction is configured to:
decapsulate the packet through a communication protocol to obtain a touch screen instruction;
wherein the touch screen instruction comprises a user operation inputted to the touch screen; and
the communication protocol comprises a user datagram protocol (UDP), a custom communication protocol or a transmission control protocol (TCP);
decapsulate the UDP packet through the UDP to obtain the control instruction;
decapsulate the custom protocol packet through the custom communication protocol to obtain the control instruction; or
decapsulate the TCP packet through the TCP to obtain the control instruction.

20. The transmitting device according to claim 17, wherein
The transmitting device further comprises: a fifth transmission medium interface configured to obtain the control instruction from a control device connected to the transmitting device; wherein
the control device connected to the transmitting device comprises a mouse, a keyboard or a user control device connected to the transmitting device; and the fifth transmission medium interface comprises a USB interface, a RS232 interface, a SPI, or an I2C interface.
